(19) United States
(12) Patent Application Publication
(10) Pub. No.: US 2019/0252096 A1
(43) Pub. Date: Aug. 15, 2019

(54) SUPERCONDUCTIVE CABLE COOLING SYSTEM HAVING INTEGRATION OF LIQUID NITROGEN CIRCULATION AND REFRIGERATOR

(71) Applicant: KOREA ELECTRIC POWER CORPORATION, Naju-si (KR)

(72) Inventors: Hyung-Suk YANG, Daejeon (KR); Seong-Woo YIM, Daejeon (KR); Song-Ho SOHN, Daejeon (KR); Sang-Cheol HAN, Daejeon (KR); Ho-Myung CHANG, Seoul (KR); Ki-Nam RYU, Yangpyeong-gun (KR)

(21) Appl. No.: 16/335,226

(22) PCT Filed: Nov. 8, 2016
(86) PCT No.: PCT/KR2016/012822

§ 371 Date: Mar. 20, 2019

(30) Foreign Application Priority Data
Sep. 21, 2016 (KR) 10-2016-0120784

(51) Int. Cl. H01B 12/16; F25B 1/10

(52) U.S. Cl. CPC H01B 12/16; F25B 1/10

(57) ABSTRACT

The present invention relates to a superconductive cable cooling system including: a refrigerator unit including a compressor and an after-cooler; a plurality of heat exchangers for performing heat exchange of a cooling fluid; an expansion valve for performing throttle expansion of the cooling fluid; an expander for adiabatically expanding the cooling fluid; a superconductive cable; and a plurality of branch points at which the cooling fluid is branched and joined, wherein the cooling fluid functions as both a refrigerant for the refrigerator unit and a coolant for the superconductive cable.

### CROSS-REFERENCE TO RELATED APPLICATIONS

This application claims the benefit under 35 U.S.C. Section 371, of PCT International Application No. PCT/KR2016/012822, filed on Nov. 08, 2016, which claimed priority to Korean Patent Application No. KR 10-2016-0120784, filed on Sep. 21, 2016, the disclosures of which are hereby incorporated by the references.

### TECHNICAL FIELD

The present invention relates to a closed cooling system applied to a superconductive cable by integrating a liquid nitrogen circulation circuit and a refrigerator unit.

### BACKGROUND ART

In general, a superconductive cable is a cable that functions on the basis of the phenomenon that a superconductor has zero electrical resistance below a certain temperature. Such a cable provides lossless transmission of electric power and can transmit much more electric current than a conventional copper cable. In a cable using high temperature superconductors (HTS), there is a cooling system in which liquid nitrogen (LN₂), which can maintain a liquid state at a temperature below minus 200 degrees Celsius and is excellent in electrical insulation performance, is used as a coolant, and liquid nitrogen is cooled and circulated through the cable. As shown in FIG. 3, a cooling system that has been mainly used recently includes a refrigerator unit for absorbing heat in liquid nitrogen and a pump (LN₂ pump) for circulating liquid nitrogen. Various types of refrigerator units are used, for example, a vacuum pump (see FIG. 3), a Stirling cooler (see FIG. 4), or a Brayton cooler (see FIG. 5) may be typically used. The cooled liquid nitrogen flows along the cable by a circulation pump while absorbing the thermal load of the cable and returns, thus completing a cooling cycle.

A cooling system using the vacuum pump is an open system which is relatively simple and can be applied to a large capacity system, but requires periodic supply of a large amount of liquid nitrogen. Accordingly, it is suitable for pilot operation in the stage of development of the superconductive cable, but it is difficult to find application in a power system requiring long unattended operation.

A cooling system using the Stirling or Brayton cooler is a closed system which can be operated continuously without a periodic supply of liquid nitrogen. However, helium (He) or neon (Ne) is used as a refrigerant, and thus the available cooling capacity of the refrigerator unit is limited, and the price thereof is very high. The cooling capacity (70 K standard) of a recently developed refrigerator is only 2 kW for the Stirling cooler, 8 kW for the Brayton cooler, and the price per kW is hundreds of thousands of dollars. These coolers have been considered as the most important obstacle for developing a superconductive cable having a length of more than 1 km. Another obstacle for increasing the length of the superconductive cable is the LN₂ pump. As the cable length becomes longer, the flow rate of liquid nitrogen to be circulated to maintain the cable below an allowable temperature (for example, 78 K) has to be increased more and thus the capacity of the LN₂ pump is also increased greatly. The LN₂ pump that has to operate at cryogenic temperature is available in some advanced countries, but the capacity (flow rate and pressure head) thereof is limited and the price thereof is very high.

### DISCLOSURE

### Technical Problem

Accordingly, the present invention has been made keeping in mind the above problems occurring in the related art, and an objective of the present invention is to provide a closed superconductive cable cooling system, in which nitrogen (N₂) functions as both a refrigerant for a refrigerator unit and a coolant for a superconductive cable, thus requiring no provision of a pump for circulating liquid nitrogen, or other expensive devices.

### Technical Solution

In order to achieve the objective of the present invention, there is provided a superconductive cable cooling system, including: a refrigerator unit including a compressor and an after-cooler; a plurality of heat exchangers for performing heat exchange of a cooling fluid; an expansion valve for performing throttle expansion of the cooling fluid; an expander for adiabatically expanding the cooling fluid; a superconductive cable; and a plurality of branch points at which the cooling fluid is branched and joined, wherein the cooling fluid functions as both a refrigerant for the refrigerator unit and a coolant for the superconductive cable.

### Advantageous Effects

According to the present invention, because helium (He) and neon (Ne) are not used as a refrigerant, general-purpose air compressors and air expanders widely used in air liquefaction plants can be used instead of components that are difficult to operate and are expensive (He/Ne compressors, He/Ne turbo expanders, or the like). Furthermore, through integration of a liquid nitrogen (LN₂) circulation circuit and a refrigerator, a pump for circulating liquid nitrogen is not required and the limit of liquid nitrogen circulation flow can be greatly increased. Furthermore, superconductive cable cooling is possible through only provision of an integrated cooling system, making it possible to enable easy operation of a cooling system while significantly reducing manufacturing cost and installation cost, and there is no possibility of freezing that exists in a superconductive cable cooling system in the related art, thus significantly increasing stability at cryogenic temperature.

### DESCRIPTION OF DRAWINGS

FIG. 1 is a view showing a table of measurements of various configurations applied to the present invention.

FIG. 2 is a view showing a table of a circulation method and cooling efficiency of a cooling cycle applied to the present invention.

FIG. 3 is a view showing an example of a cooling system in the related art (vacuum pump is used).

FIG. 4 is a view showing an example of a cooling system in the related art (a Stirling cooler is used).

FIG. 5 is a view showing an example of a cooling system in the related art (a Brayton cooler is used).

FIG. 6 is a conceptual diagram showing a superconductive cable cooling system having integration of liquid nitrogen circulation and a refrigerator according to the present invention.

FIG. 7 is a view showing an example of a large capacity standard cooling cycle (JT cycle) in the related art.

FIG. 8 is a view showing an example of a large capacity standard cooling cycle (Brayton cycle) in the related art.

FIG. 9 is a view showing an example of a large capacity standard cooling cycle (Claude cycle) in the related art.

FIG. 10 is a view showing a conceptual diagram and a table of measurements of a cooling cycle according to a first embodiment (hereinafter, referred to as a first cycle) of the present invention.

FIG. 11A to FIG. 11D are views showing graph of performance and characteristics of the first cycle according to the present invention.

FIG. 12 is a view showing a conceptual diagram and a table of measurements of a cooling cycle according to a second embodiment (hereinafter, referred to as a second cycle) of the present invention.

FIG. 13A to FIG. 13D are views showing graphs of performance and characteristics of the second cycle according to the present invention.

FIG. 14 is a view showing a conceptual diagram and a table of measurements of a cooling cycle according to a third embodiment (hereinafter, referred to as a third cycle) of the present invention.

FIG. 15A to FIG. 15D are views showing graphs of performance and characteristics of the third cycle according to the present invention.

FIG. 16 is a view showing a conceptual diagram and a table of measurements of a cooling cycle according to a fourth embodiment (hereinafter, referred to as a fourth cycle) of the present invention.

FIG. 17A to FIG. 17D are views showing graphs of performance and characteristics of the fourth cycle according to the present invention.

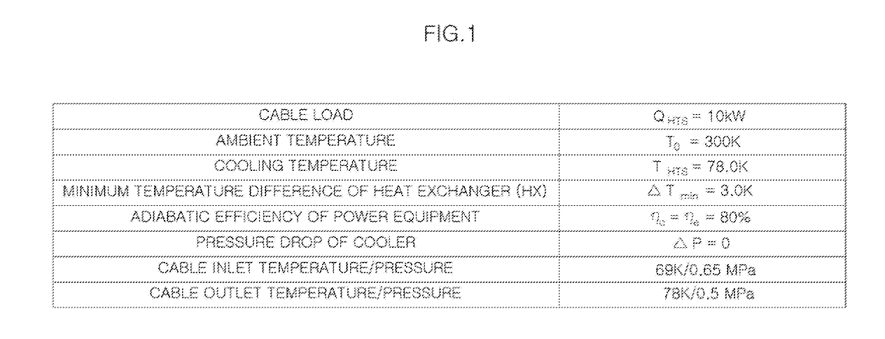

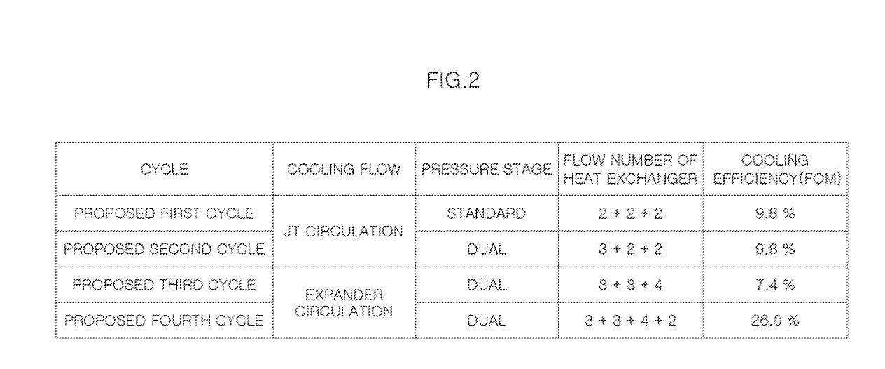

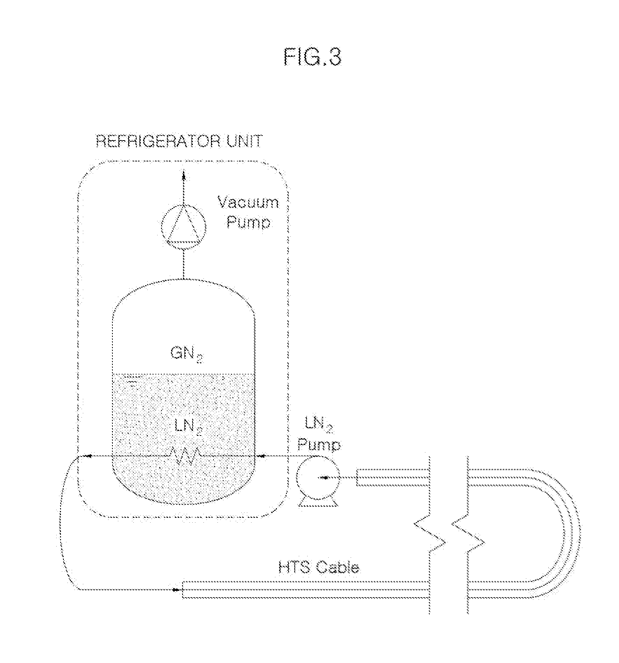

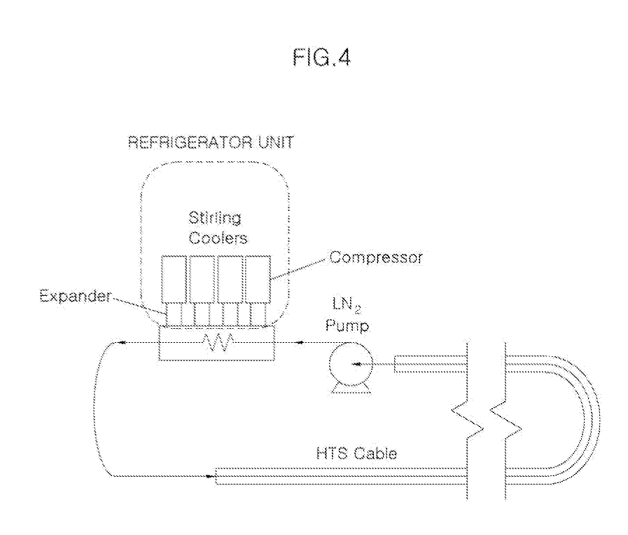

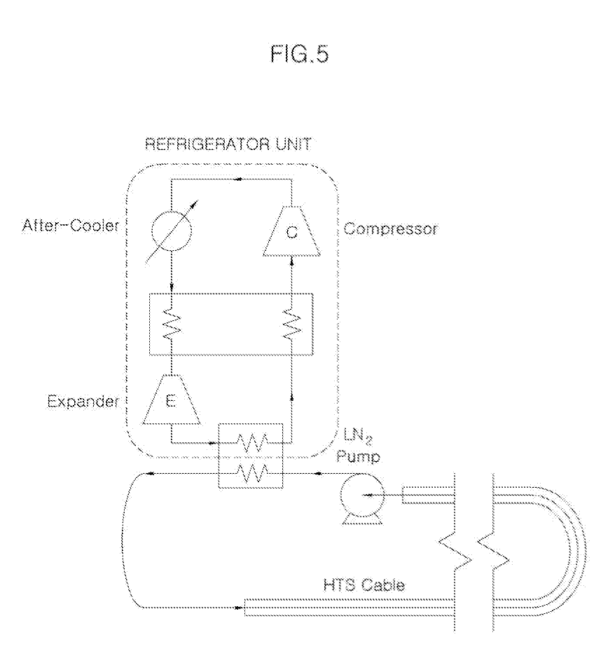

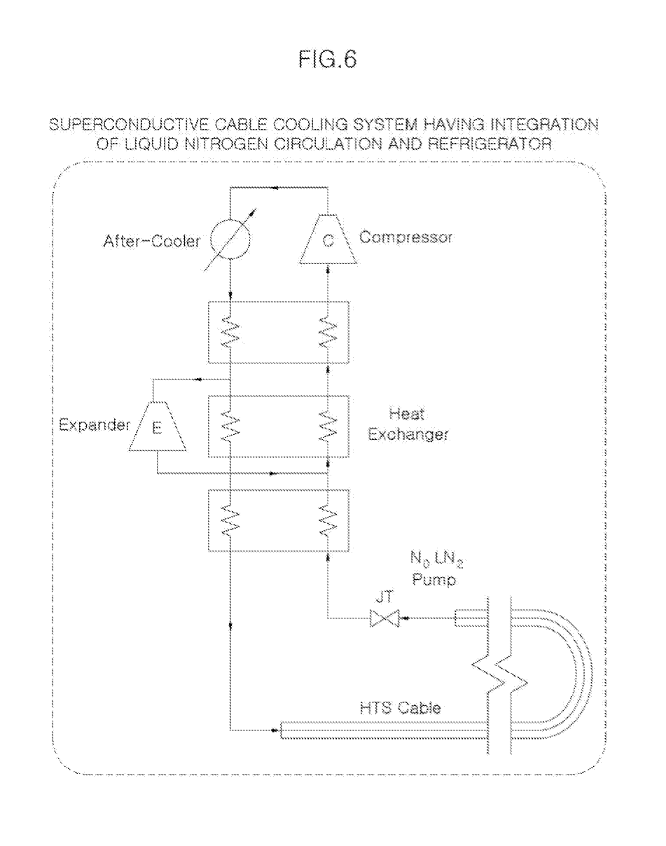

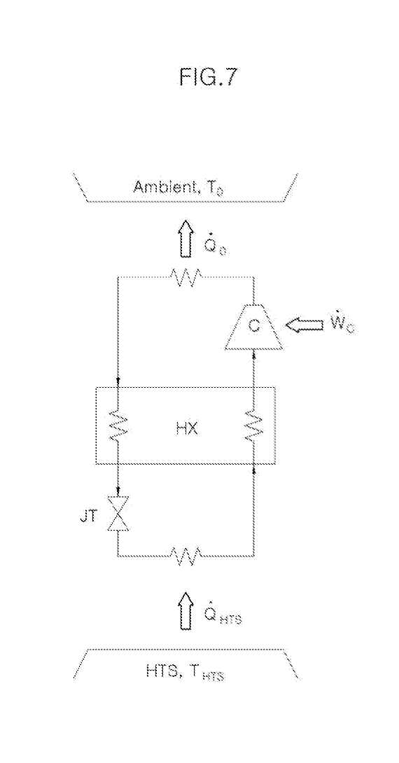

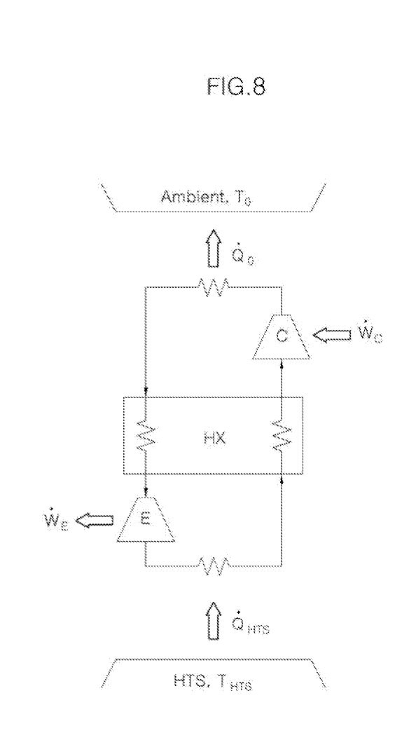

### MODE FOR INVENTION

Reference will now be made in greater detail to exemplary embodiments of the invention with reference to the accompanying drawings. The embodiments of the present invention are presented to make complete disclosure of the present invention and help those who are ordinarily skilled in the art best understand the invention. Various changes to the following embodiments are possible and the scope of the present invention is not limited to the following embodiments. Therefore, it should be understood that the shape and size of the elements shown in the drawings may be exaggeratedly drawn to provide an easily understood description of the structure of the present invention. Wherever possible, the same reference numerals will be used throughout the drawings and the description to refer to the same or like elements or parts. In the following description, it is to be noted that, when the functions of conventional elements and the detailed description of elements related with the present invention may make the gist of the present invention unclear, a detailed description of those elements will be omitted.

The present invention relates to a superconductive cable cooling system including a refrigerator unit including a compressor and an after-cooler; a plurality of heat exchangers for performing heat exchange of a cooling fluid; an expansion valve for performing throttle expansion of the cooling fluid; an expander for adiabatically expanding the cooling fluid; a superconductive cable; and a plurality of branch points at which the cooling fluid is branched and joined, wherein the cooling fluid functions as both a refrigerant for the refrigerator unit and a coolant for the superconductive cable.

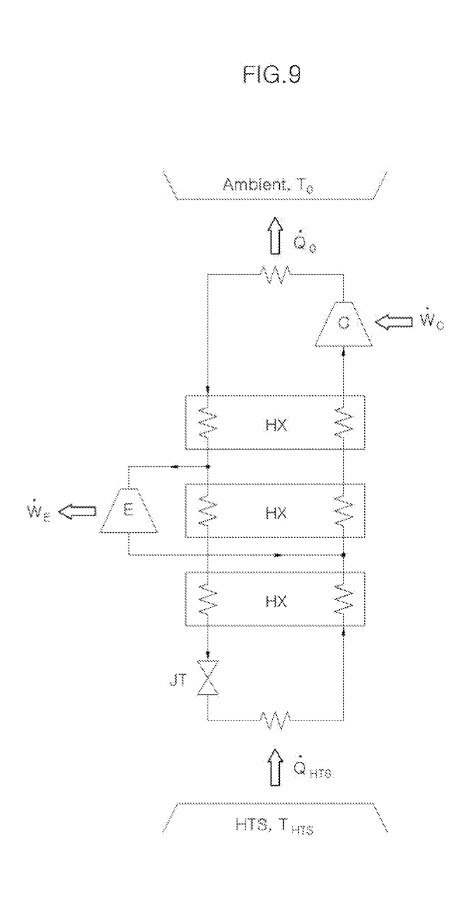

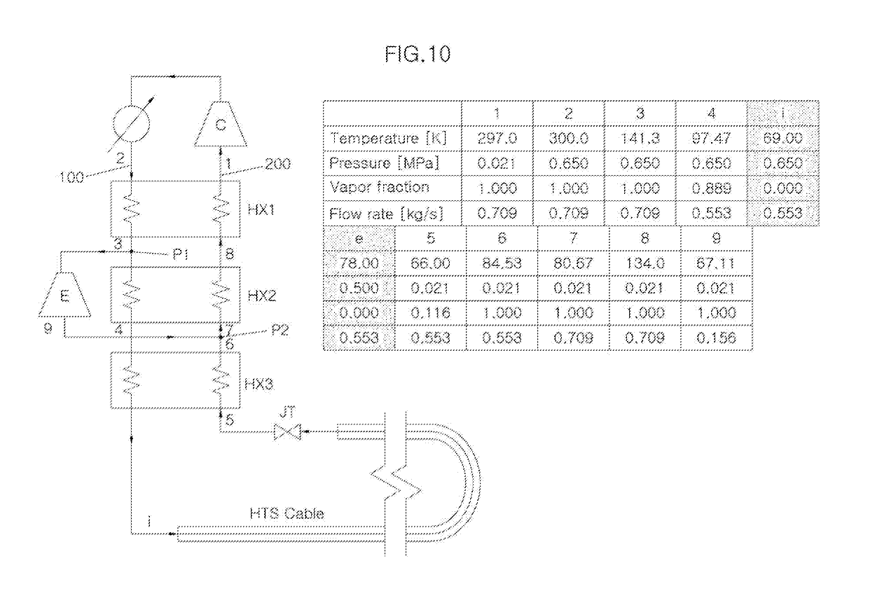

FIG. 10 is a view showing a conceptual diagram and a table of measurements of a cooling cycle according to a first embodiment (hereinafter, referred to as a first cycle) of the present invention.

In the case of the first cycle similar to a standard Claude cycle, the heat exchangers include a first heat exchanger HX1, a second heat exchanger HX2, and a third heat exchanger HX3. The heat exchangers are connected to each other in parallel in order of the first heat exchanger, the second heat exchanger, and the third heat exchanger in a direction from the refrigerator unit toward the expansion valve. The cooling fluid passes through an inlet part 100 of the heat exchangers and cools the superconductive cable. Then, the cooling fluid passes through the expansion valve and flows back to the compressor through an outlet part 200 of the heat exchangers. The branch points include a first branch point P1 located on the inlet part between the first heat exchanger and the second heat exchanger and at which the cooling fluid is branched, and a second branch point P2 located on the outlet part between the third heat exchanger and the second heat exchanger and at which the cooling fluid is joined. The cooling fluid passing through the first branch point passes through the expander and is joined at the second branch point.

In other words, a portion of the cooling fluid that is branched after being cooled through the first heat exchanger HX1 is expanded through the expander E and flows into the second heat exchanger HX2, and a remaining portion of the cooling fluid is cooled to a liquid state through the second heat exchanger HX2 and the third heat exchanger HX3 and supplied to the superconductive cable. After cooling the superconductive cable, the remaining portion of the cooling fluid is expanded to a low temperature state through the expansion valve (JT valve), cools a high-pressure refrigerant through the heat exchangers HX3, HX2, and HX1, and returns to a room temperature state. All of the heat exchangers are simple countercurrent heat exchangers, and the flow numbers thereof are in the form of 2+2+2 in order of HX1, HX2, and HX3.

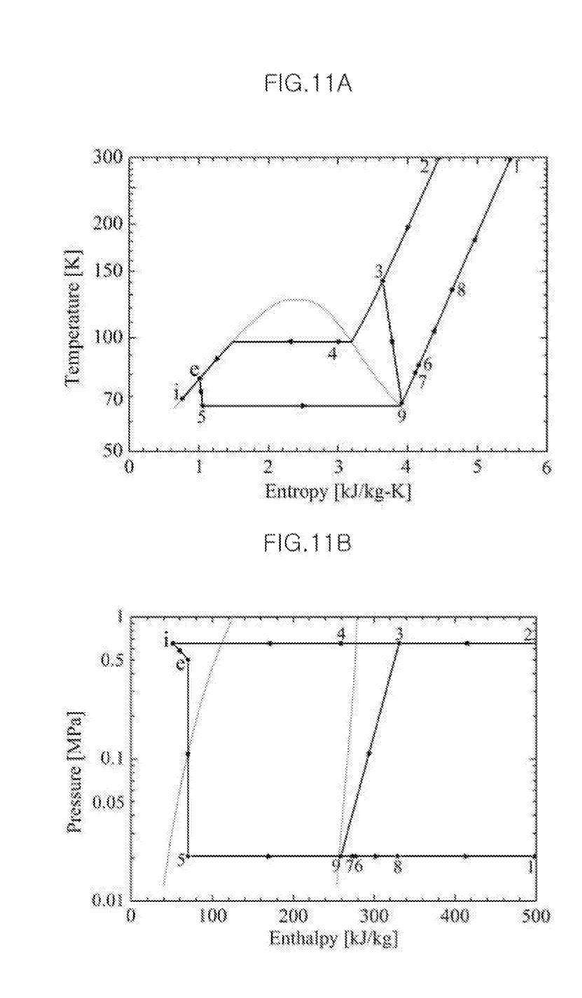

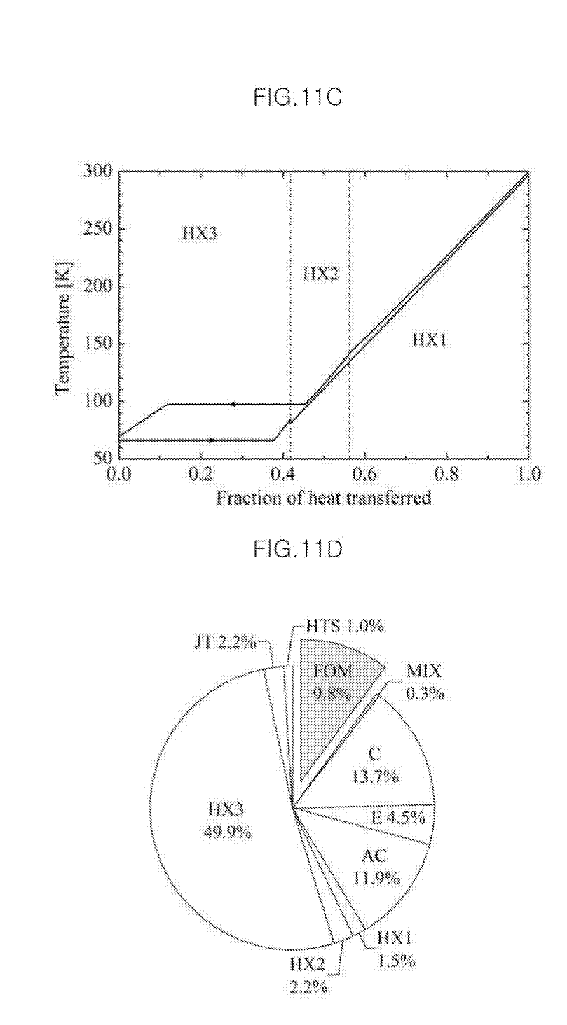

To help understand the first cycle, refer to the graphs of FIG. 11A to FIG. 11D, which show a T-s (temperature-enthalpy) diagram, a P-h (pressure-enthalpy) diagram, temperature distribution in a heat exchanger (the upper line represents Hot Composite and the lower line represents Cold Composite), and exergy consumption rate (irreversibility ratio of each component is included). Herein, i->e flow is a flow for cooling the superconductive cable, and pressure drop phenomenon at this time can be clearly observed in the P-h diagram. The efficiency is 9.84%, which is not very high due to the characteristics of a JT circulation type. However, considering the ease of manufacture and economic efficiency, the first cycle is the simplest and most realistic integrated cooling system for the superconductive cable.

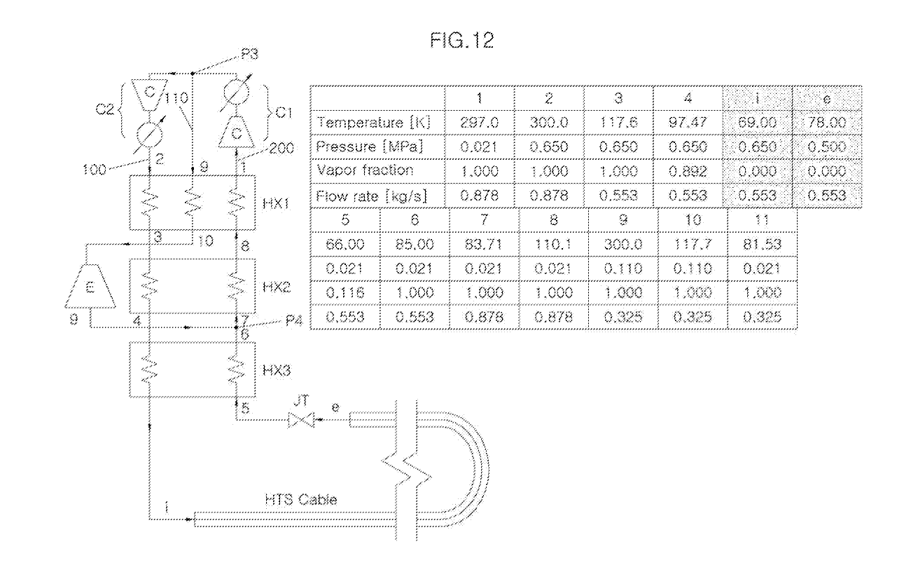

FIG. 12 is a view showing a conceptual diagram and a table of measurements of a cooling cycle according to a second embodiment (hereinafter, referred to as a second cycle) of the present invention.

In the case of the second cycle, the present invention includes a plurality of refrigerator units each including a compressor and an after-cooler; a plurality of heat exchangers for performing heat exchange of a cooling fluid; an expansion valve for performing throttle expansion of the cooling fluid; an expander for adiabatically expanding the cooling fluid; a superconductive cable; and a plurality of branch points at which the cooling fluid is branched and joined, wherein the cooling fluid functions as both a refrigerant for the refrigerator units and a coolant for the superconductive cable. The second cycle is similar to the first cycle, except that there is the plurality of refrigerator units. In the second cycle, the refrigerator units include a first refrigerator unit C1 connected to an outlet part of the heat exchangers, and a second refrigerator unit C2 connected to an inlet part of the heat exchangers, and the first and second refrigerator units are connected to each other in series. Furthermore, the heat exchangers include a first heat exchanger HX1, a second heat exchanger HX2, and a third heat exchanger HX3. The heat exchangers are connected to each other in parallel in order of the first heat exchanger, the second heat exchanger, and the third heat exchanger in a direction from the refrigerator units toward the expansion valve. The heat exchangers include a first inlet part 100 connected to the second refrigerator unit C2 and a first outlet part 200 connected to the first refrigerator unit C1, and the first heat exchanger HX1 further includes a second inlet part 110 through which the branched cooling fluid passes. Furthermore, the cooling fluid passes through the first inlet part 100 of the heat exchangers and cools the superconductive cable. Then, the cooling fluid passes through the expansion valve and flows back to the compressor of the first refrigerator unit C1 through the first outlet part 200 of the heat exchangers. The branch points of the second cycle include a first branch point P3 located between the first refrigerator unit C1 and the second refrigerator unit C2 and at which the cooling fluid is branched, and a second branch point P4 located on the first outlet part 200 between the third heat exchanger HX3 and the second heat exchanger HX2 and at which the cooling fluid is joined. The cooling fluid passing through the first branch point passes through the second inlet part of the first heat exchanger, passes through the expander, and is joined at the second branch point. The second cycle is a modified Claude cycle made by modifying the first cycle. In this case, another pressure stage is provided to constitute a dual-pressure stage, while maintaining a basic concept of the JT circulation type. In the first cycle, the pressure ratios of two flows (expander flow and JT flow) remain the same, whereas in the second cycle, the pressure ratios of two flows can be set differently, and thus there is flexibility in designing the operating pressure. The flow numbers of the heat exchangers are in the form of 3+2+2 in order of HX1, HX2, and HX3.

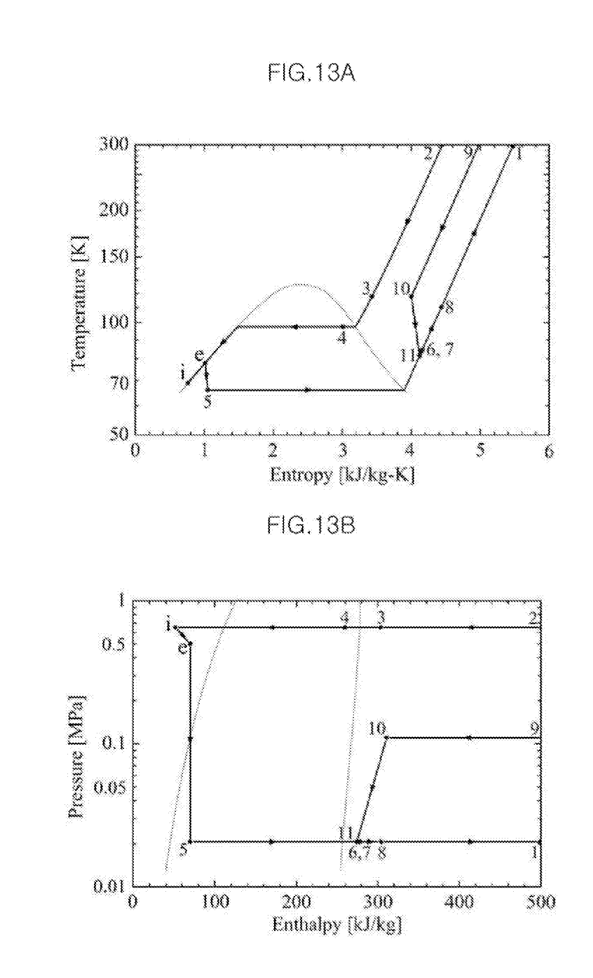

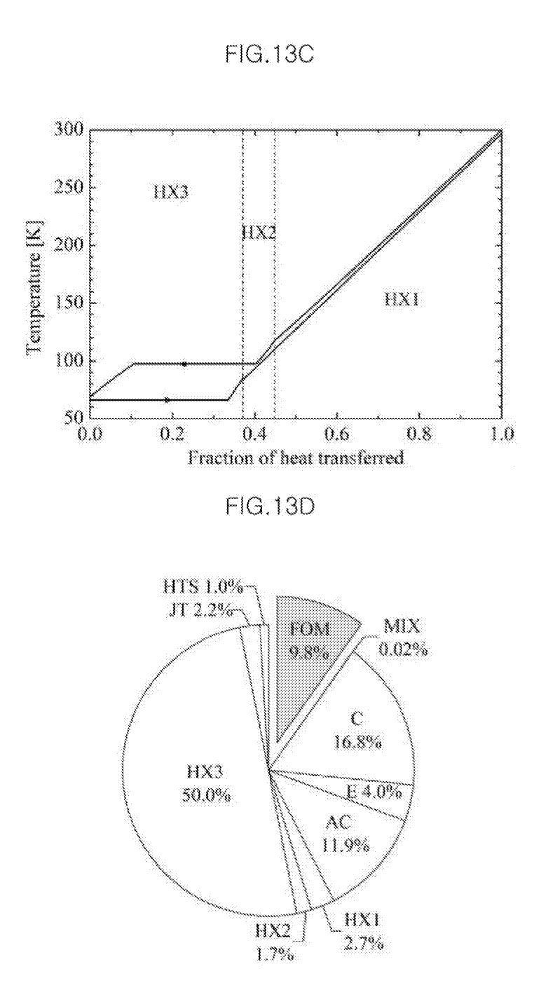

To help understand the second cycle, refer to the graphs of FIG. 13A to FIG. 13D, which show a T-s diagram, a P-h diagram, temperature distribution in a heat exchanger, and exergy consumption rate for the second cycle. Herein, i->e flow is a flow for cooling the superconductive cable. It can be seen that the efficiency of the second cycle is 9.84% similar to the first cycle, which is the maximum efficiency of the superconductive cable cooling system, which can be made in the JT circulation type under the same conditions.

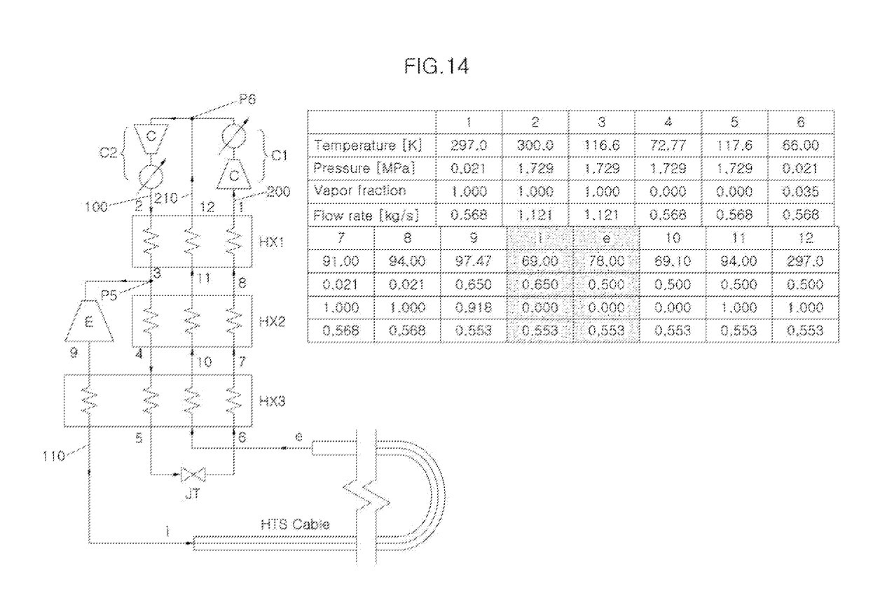

FIG. 14 is a view showing a conceptual diagram and a table of measurements of a cooling cycle according to a third embodiment (hereinafter, referred to as a third cycle) of the present invention.

The third cycle is a modified Claude cycle and is provided to overcome the efficiency limit of the JT circulation type by applying an expander circulation type rather than the JT circulation type of the first and second cycles. In the case of the third cycle, a pressure stage of the third heat exchanger is different. The heat exchangers include a first inlet part 100 connected to the second refrigerator unit C2 and a first outlet part 200 connected to the first refrigerator unit C1, and a second outlet part 210 through which the cooling fluid passing through the superconductive cable passes. The third heat exchanger HX3 further includes a second inlet part 110 connected to the expander. Furthermore, the cooling fluid passes through the first inlet part 100 of the heat exchangers, passes through the expansion valve, and flows back to the compressor of the first refrigerator unit through the first outlet part 200. The branch points of the third cycle include a first branch point P5 located on the first inlet part 100 between the first heat exchanger HX1 and the second heat exchanger HX2 and at which the cooling fluid is branched, and a second branch point P6 located between the first refrigerator unit C1 and the second refrigerator unit C2 and at which the cooling fluid is joined. The cooling fluid passing through the first branch point passes through the expander, passes through the second inlet part 110 of the third heat exchanger, passes through the superconductive cable and the second outlet part, and is joined at the second branch point. In the third cycle, the flow passing through the expander is further cooled through the third heat exchanger HX3 and supplied to the superconductive cable, and the flow passing through the JT valve constitutes a low temperature portion of each heat exchanger. The pressure stage is a dual-pressure stage, and a four-flow heat exchanger with four flows in one heat exchanger is used for the first time. The flow numbers of the heat exchangers are in the form of 3+3+4 in order of HX1, HX2, and HX3.

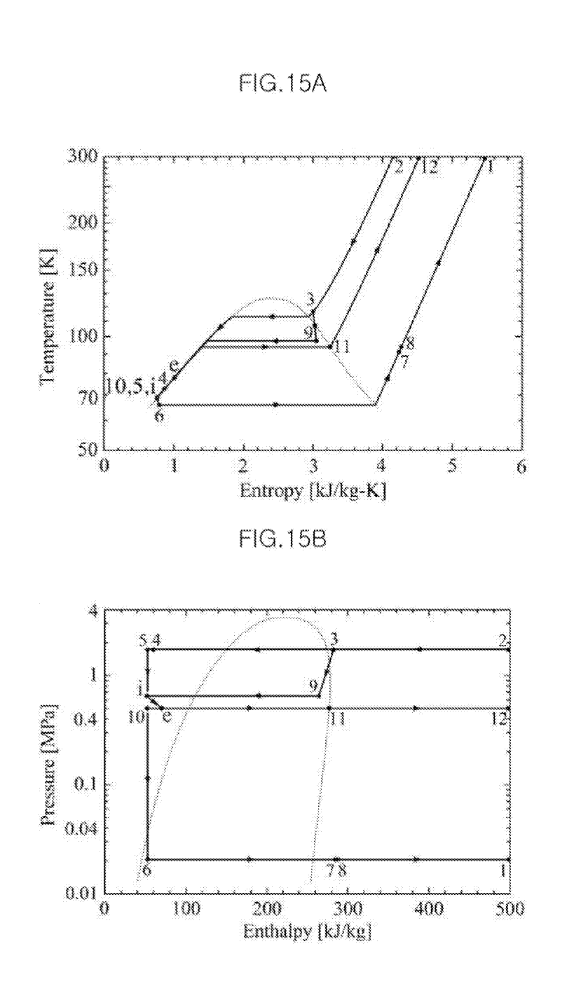

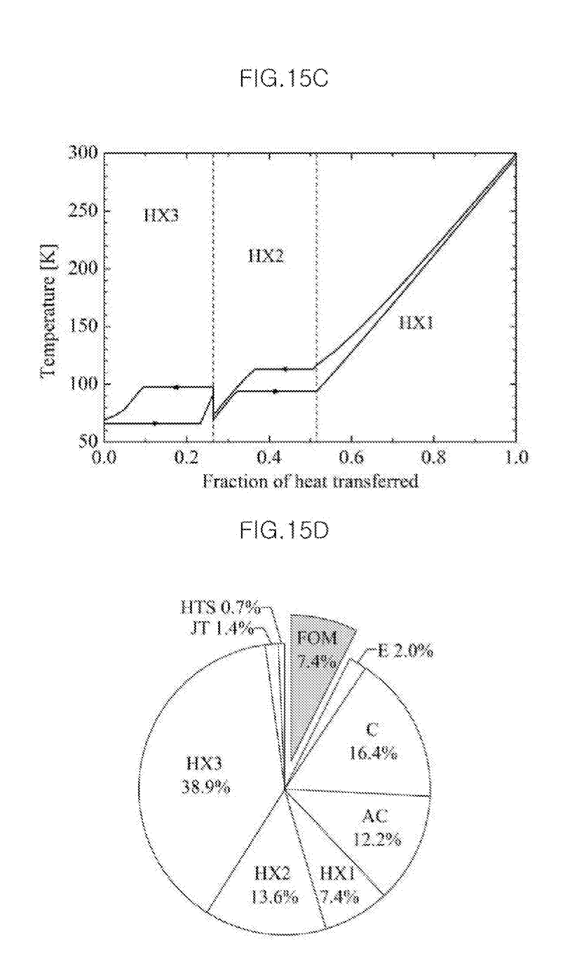

To help understand the third cycle, refer to the graphs of FIG. 15A to FIG. 15D, which show a T-s diagram, a P-h diagram, temperature distribution in a heat exchanger, and exergy consumption rate for the third cycle. Herein, i->e flow is a flow for cooling the superconductive cable. It can be seen that the efficiency of the third cycle is 7.39%, which is substantially lower than that of two cycles of the JT circulation type. This is because the temperature difference of the second heat exchanger HX2 is greatly increased.

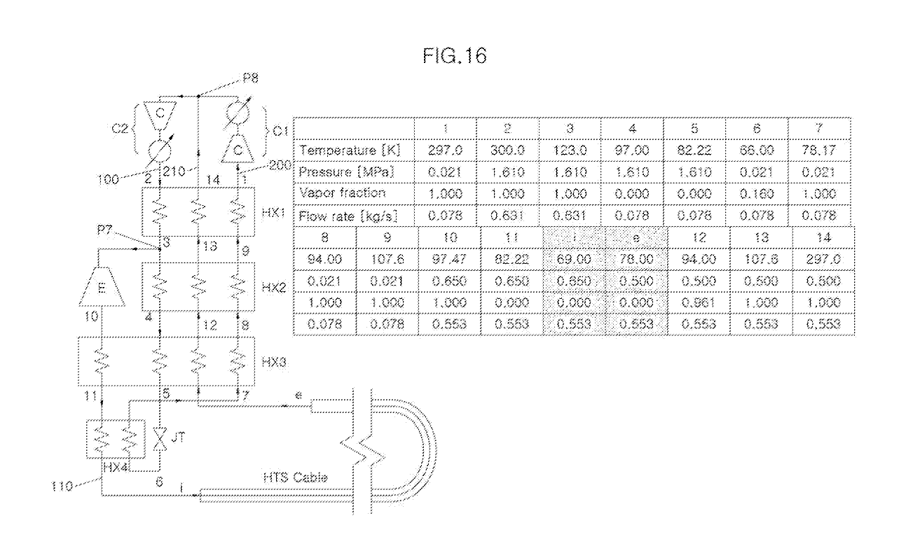

FIG. 16 is a view showing a conceptual diagram and a table of measurements of a cooling cycle according to a fourth embodiment (hereinafter, referred to as a fourth cycle) of the present invention.

The fourth cycle is also a modified Claude cycle as in the third cycle and is provided to overcome the efficiency limit of the JT circulation type by applying the expander circulation type rather than the JT circulation type. The fourth cycle further includes a fourth heat exchanger HX4. The heat exchangers are connected to each other in parallel in order of the first heat exchanger HX1, the second heat exchanger HX2, the third heat exchanger HX3, and the fourth heat exchanger HX4 in a direction from the refrigerator units toward the expansion valve. The first, second, and third heat exchangers include a first inlet part 100 connected to the second refrigerator unit C2, a first outlet part 200 connected to the first refrigerator unit C1, and a second outlet part 210 through which the cooling fluid passing through the superconductive cable passes. The third heat exchanger further includes a second inlet part 110 connected to the expander, and the fourth heat exchanger includes the second inlet part 110 and the first outlet part 200. In the fourth cycle, the cooling fluid passes through the first inlet part 100 of the heat exchangers, passes through the expansion valve, and flows back to the compressor of the first refrigerator unit through the first outlet part 200. Furthermore, the branch points of the fourth cycle include a first branch point P7 located on the first inlet part 100 between the first heat exchanger HX1 and the second heat exchanger HX2 and at which the cooling fluid is branched, and a second branch point P8 located between the first refrigerator unit C1 and the second refrigerator unit C2 and at which the cooling fluid is joined. The cooling fluid passing through the first branch point passes through the expander, passes through the second inlet part 110 of the third and fourth heat exchangers, passes through the superconductive cable and the second outlet part, and is joined at the second branch point. The number of heat exchangers in the fourth cycle is four, and the flow numbers of the heat exchanger are in the form of 3+3+4+2 in order of HX1, HX2, HX3, and HX4. The fourth heat exchanger HX4 serves to cool liquid nitrogen to low-temperature nitrogen leaving an outlet of the JT valve and supply the same to the cable.

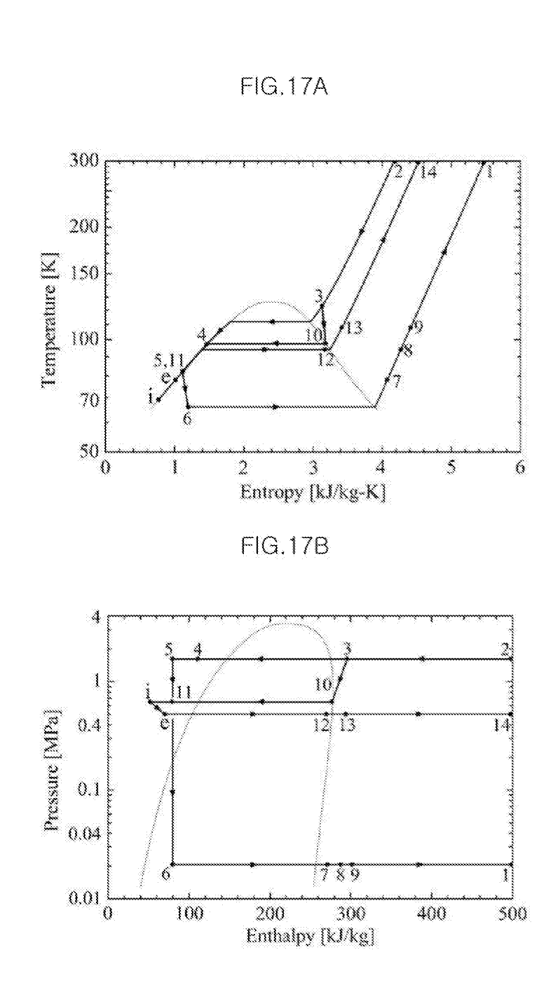

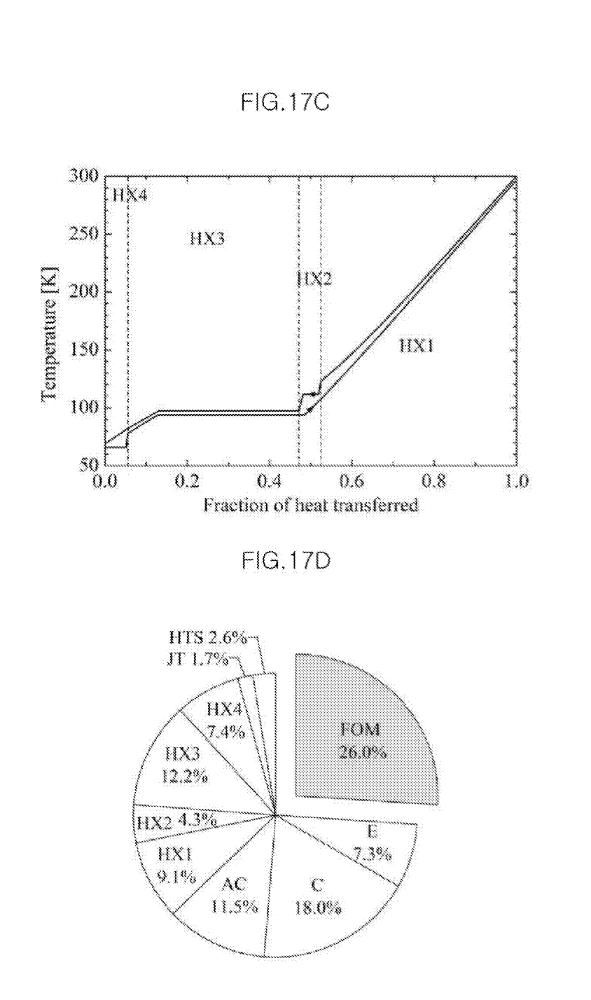

To help understand the fourth cycle, refer to the graphs of FIG. 17A to FIG. 17D, which show a T-s diagram, a P-h diagram, temperature distribution in a heat exchanger, and exergy consumption rate for the fourth cycle. Herein, i->e flow is a flow for cooling the superconductive cable. It can be seen that the efficiency is the highest among the above 1, 2, 3, and 4 cycles at an efficiency of 26.02%. The most important reason why such a high efficiency cycle is possible is that the temperature difference of the third heat exchanger HX3 is greatly reduced. This is because, as can be seen from the temperature distribution, through additional provision of the fourth heat exchanger HX4, the condensing temperature of a high temperature fluid and the boiling temperature of a low temperature fluid in the third heat exchanger HX3 are closely maintained. In the fourth cycle, the third heat exchanger HX3 is a four-flow heat exchanger having four flows, which is substantially difficult to design and manufacture. However, the third heat exchanger HX3 can be realized by a multi-flow heat exchanger widely used in industrial plants.

The cooling fluid applied in all of the cycles described so far is nitrogen, and the expansion valve may be a JT valve. Also, the term “cycle” used to help understand is expressed as a cooling system in the claims below.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. It is thus well known to those skilled in that art that the present invention is not limited to the embodiment disclosed in the detailed description, and the patent right of the present invention should be defined by the scope and spirit of the invention as disclosed in the accompanying claims. Accordingly, it should be understood that the present invention includes various modifications, additions and substitutions without departing from the scope and spirit of the invention as disclosed in the accompanying claims.

1. A superconductive cable cooling system, comprising:
a refrigerator unit including a compressor and an after-cooler;
a plurality of heat exchangers for performing heat exchange of a cooling fluid;
an expansion valve for performing throttle expansion of the cooling fluid;
an expander for adiabatically expanding the cooling fluid; a superconductive cable; and
a plurality of branch points at which the cooling fluid is branched and joined,
wherein the cooling fluid functions as both a refrigerant for the refrigerator unit and a coolant for the superconductive cable.

2. The superconductive cable cooling system of claim 1, wherein the heat exchangers include:
a first heat exchanger;
a second heat exchanger; and
a third heat exchanger,
wherein the heat exchangers are connected to each other in parallel in order of the first heat exchanger, the second heat exchanger, and the third heat exchanger in a direction from the refrigerator unit toward the expansion valve.

3. The superconductive cable cooling system of claim 2, wherein the cooling fluid passes through an inlet part of the heat exchangers, cools the superconductive cable, passes through the expansion valve, and flows back to the compressor through an outlet part of the heat exchangers.

4. The superconductive cable cooling system of claim 3, wherein the branch points include:
a first branch point located on the inlet part between the first heat exchanger and the second heat exchanger and at which the cooling fluid is branched; and
a second branch point located on the outlet part between the third heat exchanger and the second heat exchanger and at which the cooling fluid is joined,
wherein the cooling fluid passing through the first branch point passes through the expander and is joined at the second branch point.

5. A superconductive cable cooling system, comprising:
a plurality of refrigerator units each including a compressor and an after-cooler;
a plurality of heat exchangers for performing heat exchange of a cooling fluid;
an expansion valve for performing throttle expansion of the cooling fluid;
an expander for adiabatically expanding the cooling fluid;
a superconductive cable; and
a plurality of branch points at which the cooling fluid is branched and joined,
wherein the cooling fluid functions as both a refrigerant for the refrigerator units and a coolant for the superconductive cable.

6. The superconductive cable cooling system of claim 5, wherein the refrigerator units include:
a first refrigerator unit connected to an outlet part of the heat exchangers; and
a second refrigerator unit connected to an inlet part of the heat exchangers,
wherein the first and second refrigerator units are connected to each other in series.

7. The superconductive cable cooling system of claim 6, wherein the heat exchangers include:
a first heat exchanger;
a second heat exchanger; and
a third heat exchanger,
wherein the heat exchangers are connected to each other in parallel in order of the first heat exchanger, the second heat exchanger, and the third heat exchanger in a direction from the refrigerator units toward the expansion valve.

8. The superconductive cable cooling system of claim 7, wherein the heat exchangers include:
a first inlet part connected to the second refrigerator unit; and
a first outlet part connected to the first refrigerator unit,
wherein the first heat exchanger includes a second inlet part through which the branched cooling fluid passes.

9. The superconductive cable cooling system of claim 8, wherein the cooling fluid passes through the first inlet part of the heat exchangers, cools the superconductive cable, passes through the expansion valve, and flows back to the compressor of the first refrigerator unit through the first outlet part of the heat exchangers.

10. The superconductive cable cooling system of claim 9, wherein the branch points include:
a first branch point located between the first refrigerator unit and the second refrigerator unit and at which the cooling fluid is branched; and
a second branch point located on the first outlet part between the third heat exchanger and the second heat exchanger and at which the cooling fluid is joined,
wherein the cooling fluid passing through the first branch point passes through the second inlet part of the first heat exchanger, passes through the expander, and is joined at the second branch point.

11. The superconductive cable cooling system of claim 7, wherein the heat exchangers include:
a first inlet part connected to the second refrigerator unit;
a first outlet part connected to the first refrigerator unit; and
a second outlet part through which the cooling fluid passing through the superconductive cable passes,
wherein the third heat exchanger includes a second inlet part connected to the expander.

12. The superconductive cable cooling system of claim 11, wherein the cooling fluid passes through the first inlet part of the heat exchangers, passes through the expansion valve, and flows back to the compressor of the first refrigerator unit through the first outlet part.

13. The superconductive cable cooling system of claim 12, wherein the branch points include:
a first branch point located on the first inlet part between the first heat exchanger and the second heat exchanger and at which the cooling fluid is branched; and
a second branch point located between the first refrigerator unit and the second refrigerator unit and at which the cooling fluid is joined,
wherein the cooling fluid passing through the first branch point passes through the expander, passes through the second inlet part of the third heat exchanger, cools the superconductive cable, and is joined at the second branch point through the second outlet part.

14. The superconductive cable cooling system of claim 6, wherein the heat exchangers include:
a first heat exchanger;
a second heat exchanger;
a third heat exchanger; and
a fourth heat exchanger,
wherein the heat exchangers are connected to each other in parallel in order of the first heat exchanger, the second heat exchanger, the third heat exchanger, and the fourth heat exchanger in a direction from the refrigerator units toward the expansion valve.

15. The superconductive cable cooling system of claim 14, wherein the first, second, and the third heat exchangers include:
a first inlet part connected to the second refrigerator unit;
a first outlet part connected to the first refrigerator unit; and
a second outlet part through which the cooling fluid passing through the superconductive cable passes,
wherein the third heat exchanger includes a second inlet part connected to the expander.

16. The superconductive cable cooling system of claim 15, wherein the fourth heat exchanger includes the second inlet part and the first outlet part.

17. The superconductive cable cooling system of claim 16, wherein the cooling fluid passes through the first inlet part of the heat exchangers, passes through the expansion valve, and flows back to the compressor of the first refrigerator unit through the first outlet part.

18. The superconductive cable cooling system of claim 17, wherein the branch points include:
a first branch point located on the first inlet part between the first heat exchanger and the second heat exchanger and at which the cooling fluid is branched; and
a second branch point located between the first refrigerator unit and the second refrigerator unit and at which the cooling fluid is joined,
wherein the cooling fluid passing through the first branch point passes through the expander, passes through the second inlet part of the third and fourth heat exchangers, cools the superconductive cable, and is joined at the second branch point through the second outlet part.

19. The superconductive cable cooling system of claim 1, wherein the cooling fluid is nitrogen.

20. The superconductive cable cooling system of claim 1, wherein the expansion valve is a JT valve.
